(19) United States
(12) Patent Application Publication
(10) Pub. No.: US 2018/0255869 A1
(43) Pub. Date: Sep. 13, 2018

(54) Outsole and Method of Making the Same

(71) Applicant: Jonathan K. Lebo, Lebanon, PA (US)

(72) Inventor: Jonathan K. Lebo, Lebanon, PA (US)

(73) Assignee: Columbia Insurance Company, Omaha, NE (US)

(21) Appl. No.: 15/454,922

(22) Filed: Mar. 9, 2017

(51) Int. Cl. A43B 13/14; A43B 23/08; B29C 33/44

(52) U.S. Cl. CPC A43B 13/14; B29L 2031/504; B29C 33/44; A43B 23/081

(57) ABSTRACT

Disclosed are an improved outsole and method of making the same. This method provides increased flexibility and comfort, more efficient material utilization, greatly improved protection to the wearer, and aesthetic appeal. More specifically, the improved outsole includes an integrally connected rigid material and toe cap.

### FIELD OF THE INVENTION

This invention relates to an improved outsole and method of making the same.

### BACKGROUND OF THE ART

Safety footwear is often required in a variety of situations. A primary function of safety footwear, such as safety boots or shoes, is generally to protect the foot against impacts, falling items, electrical shock, and moisture among other things. Accordingly, some items of footwear may include a toe-cap to protect the toe region of the foot. The toe-cap sometimes defines a volume accommodating the toes of the wearer in the item of footwear so as to protect the toes against the impact from objects falling against the footwear, striking a hard material with the toe region of the shoe, electrical and static shock, and unwanted water damage. In some safety footwear, the toe-cap is within the upper and is therefore under the leather or synthetic material forming the exposed surface of the upper. As the material of the upper is above that of the toe-caps, the material of the upper often rips or is damaged over time as a result of abrasion and impact, thereby exposing the toe-cap material. As they are even used as “hammers” to kick objects, safety boots with toe-caps often wear out prematurely in the toe region. In yet some other footwear, the toe-cap is often secured above the upper via cementing or stitching. Due to this type of construction, there is often an inherent weakness between the upper, toe-cap, and outsole, which often causes poor impact and shock absorption as well as premature wear and tear of the toe-cap. Additionally, this type of manufacturing procedure often requires added time and expense because more steps are involved

Some toe-caps are cemented or stitched to the outsole prior to the soling process and a portion of such toe-caps is often folded and secured under the edge of the last. None of these constructions have an extension below the edge of the last and form weak junctions between the toe-cap and outsole.

Therefore, there remains a weakness at the junction between the toe-cap and outsole as well as between the midsole and outsole, in the toe-end region of the item of footwear. The toe-end region is subject to abrasion, compression, penetration, and/or intense electrical and static shocks. The weakness is particularly notable in footwear with a cemented or stitched construction between the toe-cap and outsole, as this type of assembly accentuates the separation of the different parts of outsole and of the toe cap.

Thus, there is a need for an efficient method of outsole construction that offers a wearer all the necessary protections from various impacts and shocks while adding shelf-life to the outsole and toe cap via improved construction.

### SUMMARY OF THE INVENTION

It is therefore an object of this invention to provide a method for forming an improved outsole of a shoe. In one embodiment, the method comprises the steps of providing a raw material; extending a first part of said raw material forward for forming a toe region; extending a second part of said raw material away from said first part for forming a heel region; placing a rigid material onto a top portion of said toe region; and shaping a toe cap by extending said top portion of said toe region around said rigid material. In another embodiment, the method further comprises a step of extending said top portion of said toe region generally upwards and generally perpendicular to an upper portion of said outsole for forming a first edge. In another embodiment, the method further comprises a step of extending said first edge rearwardly and generally parallel to said upper portion of said outsole. In another embodiment, the method further comprises a step of extending a side of said outsole upwards and generally perpendicular to said upper portion of said outsole for forming a second edge. In another embodiment, the method further comprises a step of connecting said first and second edges for forming said toe cap. In another embodiment, the method further comprises a step of integrally connecting said outsole and said toe cap for forming said outsole toe cap around said rigid material.

In one embodiment of this invention, an outsole for a shoe is provided. The outsole comprises a bottom surface; a top surface; a heel region; a toe region; and a midsole region; wherein said toe region includes a protrusion that extends generally perpendicular in relation to said top surface to produce a generally perpendicular front region; and said protrusion further extends rearward toward said heel region and generally parallel in relation to said top surface to produce a toe cap. In another embodiment, the outsole further comprises a toe cap further including sidewalls. In another embodiment, the outsole further comprises sidewalls that are secured to a peripheral edge of said toe region. In another embodiment, the outsole further comprises a toe cap further including an open cavity defined by a rearward facing edge. In another embodiment, the outsole further comprises a piece of rigid material secured to said toe region. In another embodiment, the outsole comprises a rigid material encapsulated within said toe cap. In another embodiment, the outsole is formed from a first raw material. In another embodiment, the toe cap is formed from a second raw material. In another embodiment, the toe cap and outsole are integrally connected as a single piece.

In one embodiment of this invention, a method of forming an outsole for a shoe comprises the steps of providing a first raw material; shaping said first raw material into an outsole having a bottom surface and an upper surface; extending a front region of said upper surface generally upwards and generally perpendicular to said upper surface of said outsole; further extending said front region of said upper surface generally rearwards and generally parallel to said upper surface of said outsole; providing said front region with a peripheral edge; extending a first side portion of said upper surface generally upwards and generally perpendicular to said upper surface of said outsole; extending a second side portion said upper surface generally upwards and generally perpendicular to said upper surface of said outsole; providing said first and second side portions with a peripheral edge; joining said peripheral edge of said front region, said peripheral edge of said first side portion; and said peripheral edge of said second side portion for defining a continuous, rearward facing toe cap edge integrally connected with said outsole. In another embodiment, the method further comprises a step of integrally connecting a rigid piece within said toe cap. In another embodiment, the method further comprises the steps of extending said peripheral edge of said front region for covering said rigid material; extending said peripheral edge of said first side portion for covering said rigid material; and extending said peripheral edge of said second side portion for covering said rigid material. In another embodiment, the method further comprises the step of connecting each of said peripheral edge of said front region, said peripheral edge of said first portion, and said peripheral edge of said second side portion for fully covering said rigid material. In another embodiment, the method for comprises the steps of extending a top portion of said peripheral edge of said front region for covering an upper surface of said rigid material; extending a bottom portion of said peripheral edge of said front region for covering a bottom surface of said rigid material; extending a top portion of said peripheral edge of said first side portion for covering said upper surface of said rigid material; extending a bottom portion of said peripheral edge of said first side portion for covering said bottom surface of said rigid material; extending a top portion of said peripheral edge of said second side portion for covering said upper surface of said rigid material; extending a bottom portion of said peripheral edge of said second side portion for covering said bottom surface of said rigid material; and connecting said top and bottom portions of said peripheral edge of said front region, said top and bottom portions of said peripheral edge of said first side portion, and said top and bottom portions of said peripheral edge of said second side portion.

### BRIEF DESCRIPTION OF THE DRAWINGS

FIG. 1 is a top view of an outsole for a shoe in accordance with this invention.

FIG. 2 depicts a mold for forming the outsole according to FIG. 1.

FIG. 3 depicts an open view of the mold for forming the outsole of FIG. 1.

FIG. 4 depicts the bottom lid of the mold for forming the outsole of FIG. 1.

FIG. 5 depicts a closed view of the mold for forming the outsole of FIG. 1.

FIG. 6 depicts the toe cap lid of the mold for forming the outsole of FIG. 1.

FIG. 7 depicts an open view of the mold for forming the outsole of FIG. 1.

FIG. 8 depicts a raw material that forms the outsole of FIG. 1.

FIG. 9 is a side view of the outsole of FIG. 1.

FIG. 10 is a top view of a rigid material for the outsole of FIG. 1.

FIG. 11 is a rear view of the rigid material for the outsole of FIG. 1.

FIG. 12 is a front view of the rigid material for the outsole of FIG. 1.

FIG. 13 is a perspective view of the rigid material for the outsole of FIG. 1.

FIG. 14 is a perspective view of the outsole of FIG. 1.

FIG. 15 is a second top view of the outsole of FIG. 1.

FIG. 16 is a cross-section view of the outsole of FIG. 1.

FIG. 17 is a cross-section view of the outsole of FIG. 1.

FIG. 18 depicts the outsole of FIG. 1 without a toe cap.

FIG. 19 depicts a method of forming the outsole of FIG. 1.

FIG. 20 depicts a method of forming the outsole of FIG. 1.

### DETAILED DESCRIPTION OF THE INVENTION

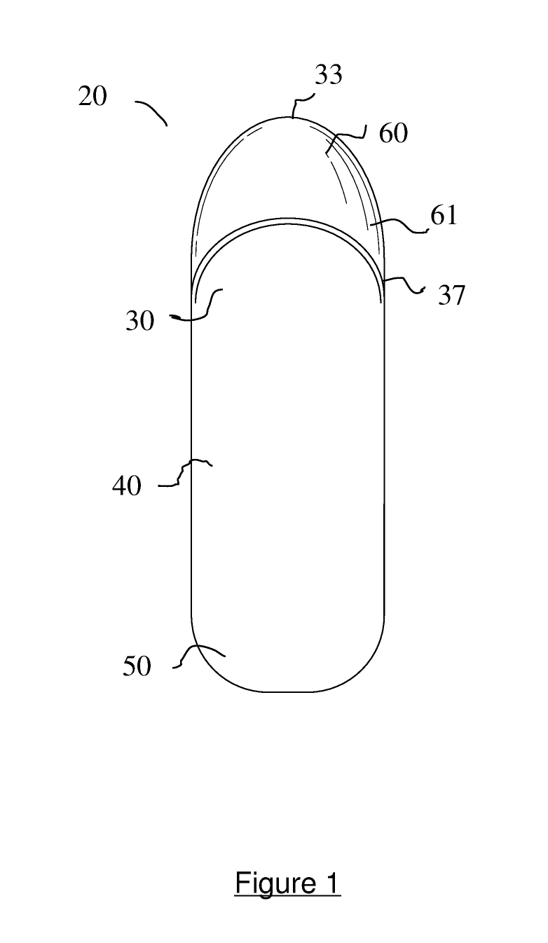

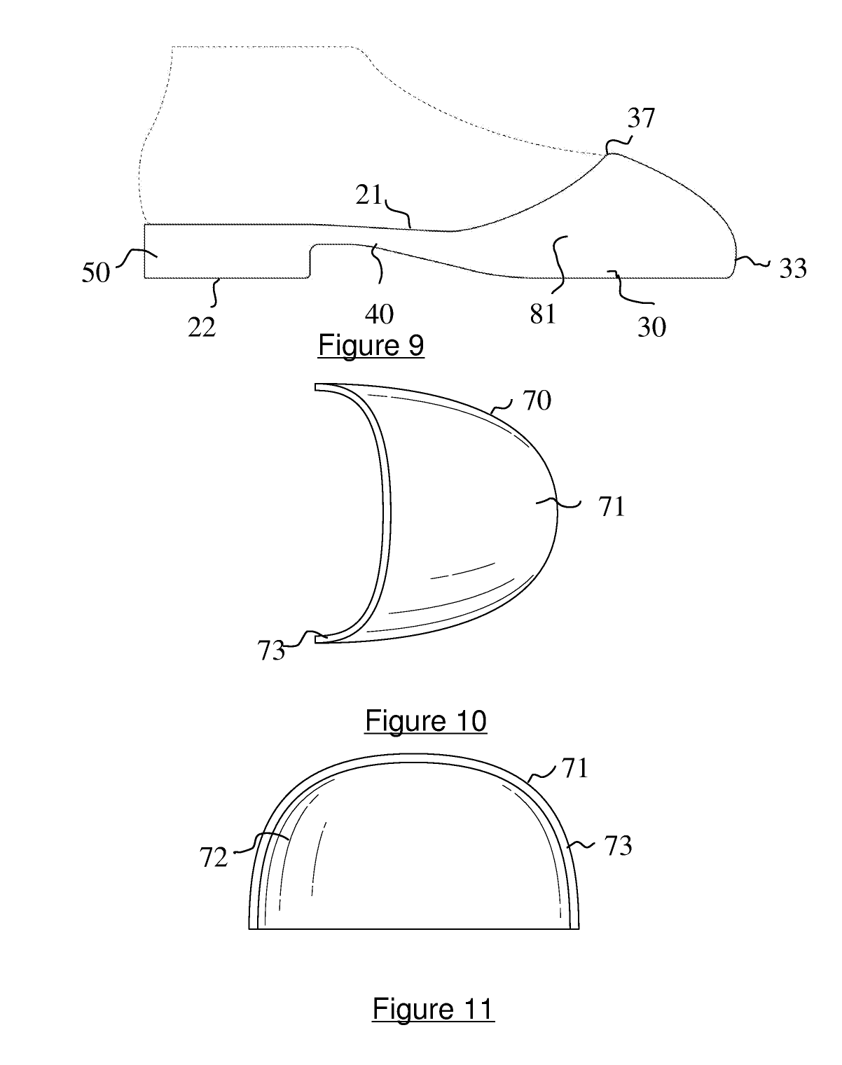

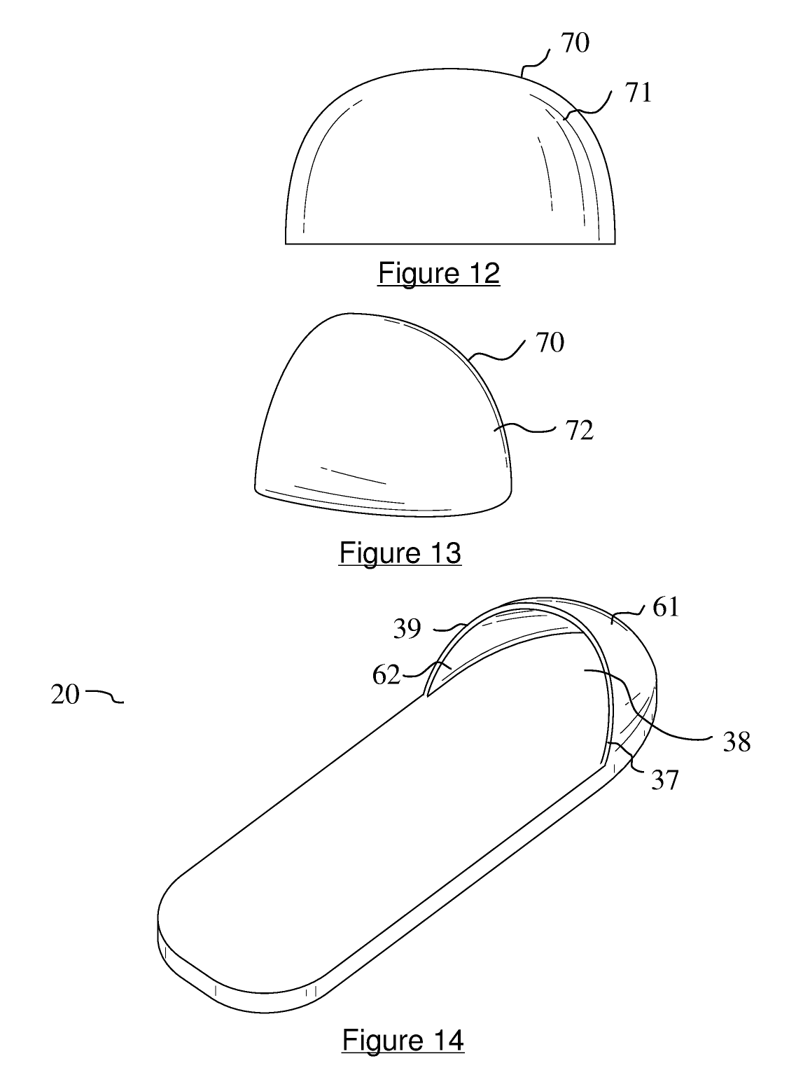

The present invention related to an improved outsole and method of making the same. As shown in FIGS. 1 and 9, in one embodiment of this invention, an outsole (20) is formed having a bottom surface (22), a top surface (21), a heel region (50), a toe region (30), and a midsole region (40); wherein said toe region (30) further includes a protrusion (33) that extends generally upward in relation to said top surface (21) to produce a generally perpendicular front region (33); and said protrusion (33) further extends generally rearward toward said heel region (50) and generally parallel in relation to said top surface (21) of said outsole (20) to produce a toe cap (60), as shown in FIG. 9.

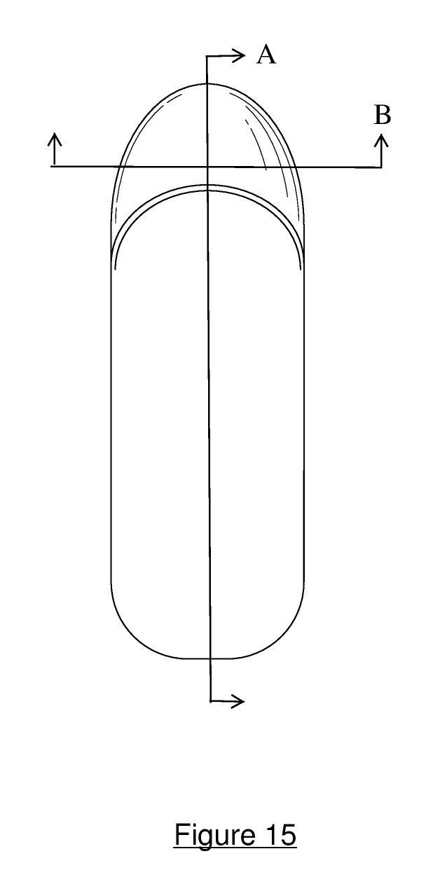

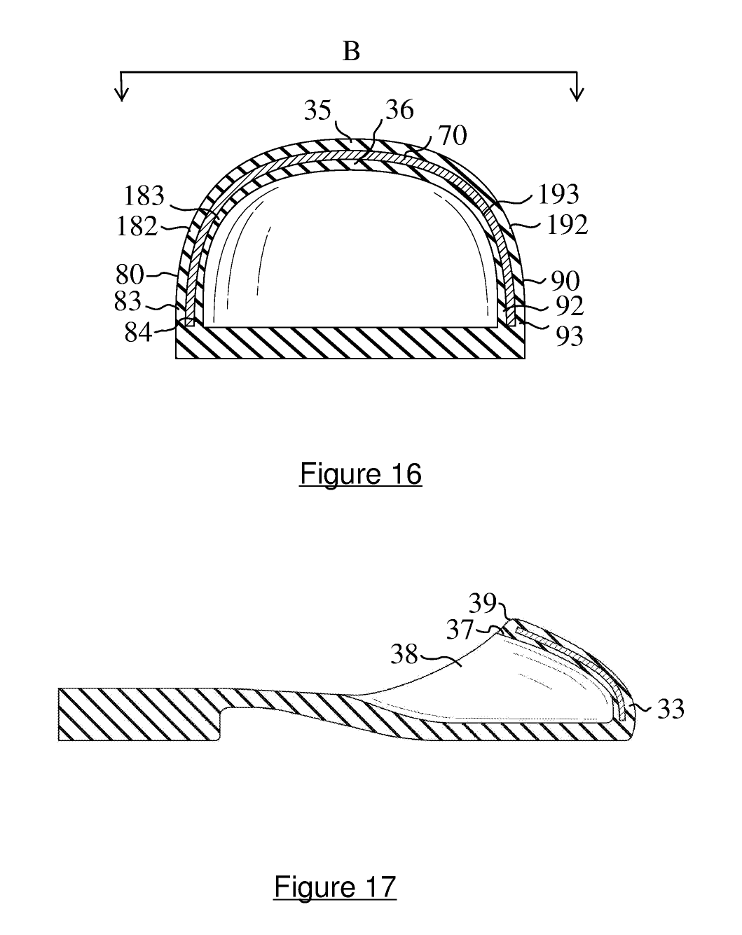

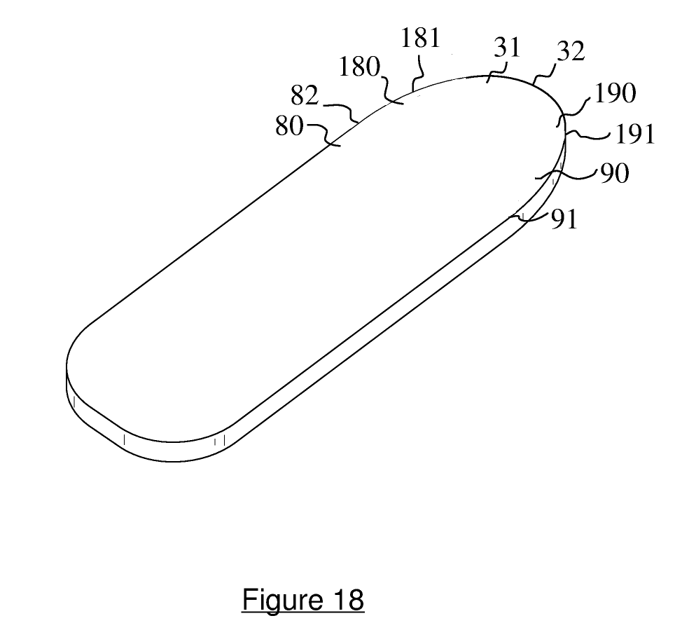

In another embodiment as shown in FIG. 9, the toe cap (60) further includes sidewalls (81). In another embodiment as shown in FIG. 18, the toe region (30) further includes a peripheral edge (32). In another embodiment as shown in FIG. 9, the sidewalls (81) are secured to the peripheral edge (32) of the toe region (30). In another embodiment as shown in FIG. 14, the toe cap further includes an open cavity (38). In another embodiment, the open cavity (38) is defined by an edge (37). In another embodiment as shown in FIG. 1, this edge (37) is rearward facing. In yet another embodiment, a rigid material (70) is integrally connected with the outsole (20). In another embodiment as shown in FIGS. 16-17, the rigid material (70) is encapsulated within the toe cap (60). In another embodiment, the outsole (20) is formed by a first material (10). In another embodiment, the toe cap (60) is formed by a second material. In yet another embodiment as shown in FIGS. 1 and 9, the toe cap (60) is integrally connected with the outsole (20).

In one embodiment as shown in FIG. 14, the toe cap (60) further consists of a top layer (61) and a bottom layer (62), wherein the top layer (61) is extended over a top surface (71) of a rigid material (70), and the bottom layer (62) is extended over a bottom surface (72) of the rigid material (70). In another embodiment, the top (61) and bottom (62) layers of the toe cap (60) connect to form the rearward facing toe cap edge (37), as shown in FIGS. 14 and 17. In another embodiment as shown in FIG. 10, the rigid material further includes a rearward facing edge (73). In one embodiment as shown in FIG. 17, the top (61) and bottom (62) layers of the toe cap (60) connect adjacent (39) the rigid material rearward facing edge (73), surrounding the rigid material rearward facing edge (73).

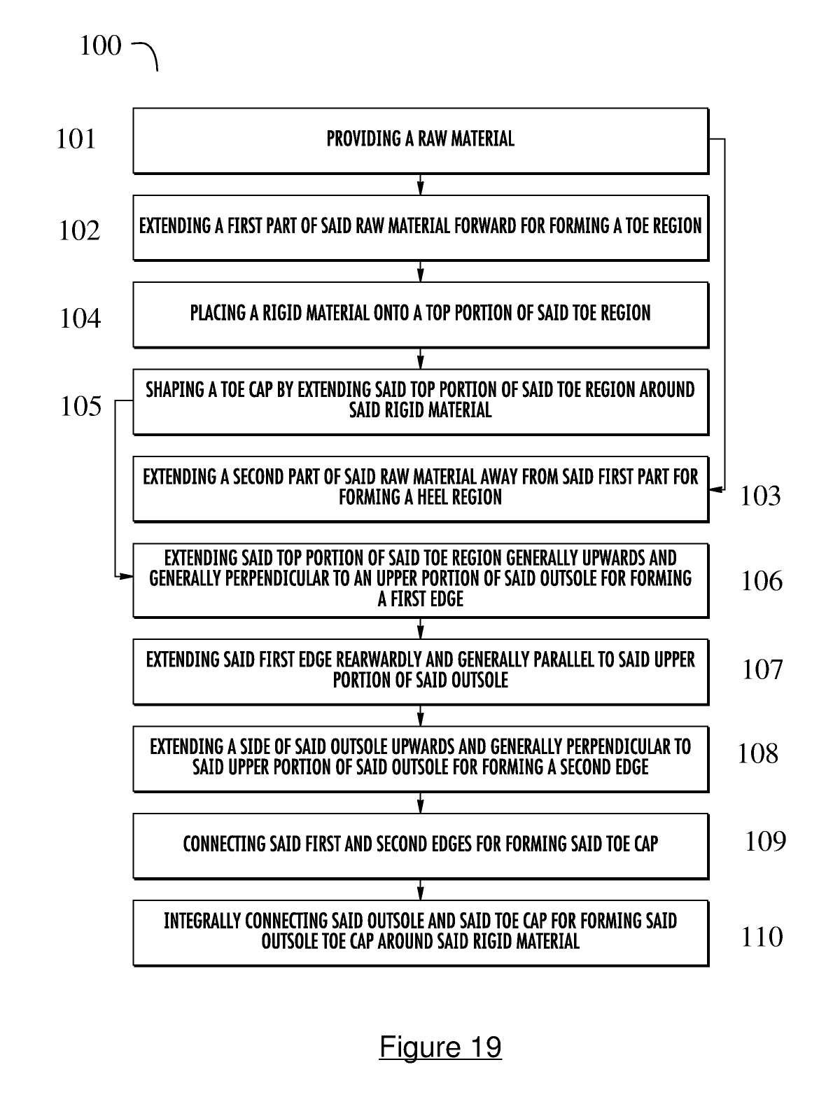

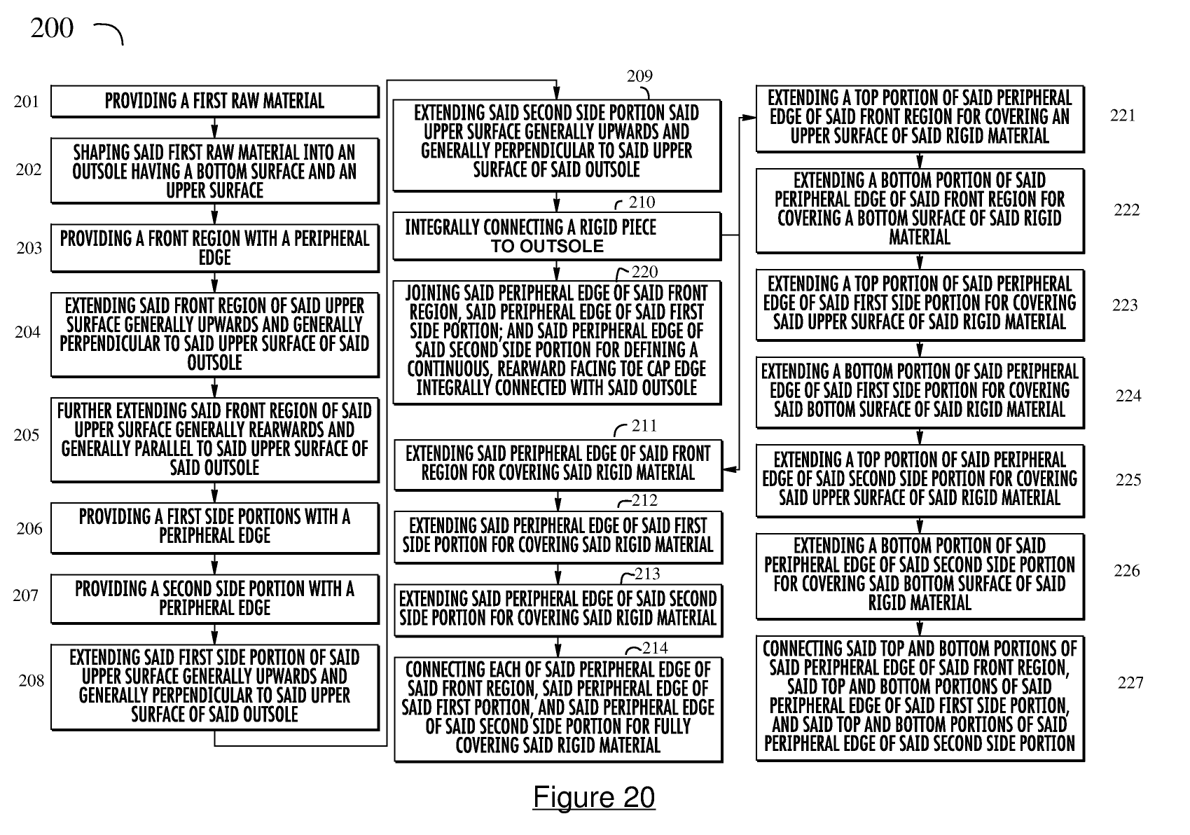

In one embodiment as shown in FIG. 19, a method (100) for forming an outsole (20), shown in FIG. 1, for a shoe comprises a step (101) of providing a raw material (10) having a first part (10a) and a second part (10b); a step of providing each of the first (10a) and second (10b) parts with each an upper portion (21) and a bottom portion (22); a step (102) of extending the first part (10a) for forming a toe region (30); a step (103) of extending the second part (10b) away from the first part (10a) for forming a heel region (50); a step (104) of placing a rigid material (70) onto a top portion (31) of the toe region (30); and a step (105) of shaping a toe cap (60) by extending the top portion (31) of the toe region (30) around the rigid material (70).

In another embodiment as shown in FIG. 19, the step (105) of shaping the toe cap (60) further comprises the step (106) of extending the top portion (31) of the toe region (30) generally upwards and generally perpendicular to the upper portion (21) of the outsole (20) for forming a first edge (32); a step (107) extending the first edge (32) toward the heel region (50) and generally parallel to the upper portion (21) of the outsole (20); a step (108) of extending a side (80) of the outsole (20) generally upwards and generally perpendicular to the upper portion (21) of the outsole (20) for forming a second edge (82); a step (109) of connecting the first (32) and second (82) edges for forming the toe cap (60) around said rigid material (70); and a step (110) of integrally connecting said toe cap (60) and said outsole (20).

In yet another embodiment, the step (105) of shaping the toe cap (60) further comprises a step (108) of extending a side (80) of the outsole generally upwards and generally perpendicular to the upper portion (21) of the outsole (20) for forming a third edge (181), as shown in FIG. 18; a step (109) of connecting the first (32), second (82), and third (181) edges for forming the toe cap (60) around the rigid material (70); and a step (110) of integrally connecting said toe cap (60) and said outsole (20).

In yet another embodiment, the step (110) of integrally connecting the toe cap (60) with the outsole (20) takes place before the step (109) of connecting the first (32) and second (82) edges. In another embodiment, the step (110) of integrally connecting the toe cap (60) with the outsole (20) takes place before the step of connecting the first (32), second (82), and third (181) edges.

In yet another embodiment, the step (105) of shaping the toe cap (60) further comprises a step (108) of extending a side (80) of the outsole (20) generally upwards and generally perpendicular to the upper portion (21) of the outsole (20) for forming a fourth (191) edge, as shown in FIG. 18; a (109) of connecting the first (32), second (82), third (181), and fourth (191) edges for forming the toe cap (60) around the rigid material (70); and a step (110) of integrally connecting said toe cap (60) and said outsole (20).

In one embodiment as shown in FIG. 20, a method (200) for forming an outsole (20) for a shoe comprises the step (201) of providing a first raw material (10); a step (202) of shaping said raw material (10) into an outsole (20) having a bottom surface (22) and an upper surface (21); a step (103) of providing a front region (30) of the outsole (20) with a peripheral edge (32); a step (204) of extending the front region (30) of the upper surface (21) generally upwards and generally perpendicular to said upper surface (21); a step (205) of further extending said front region (30) generally rearwards and generally parallel to the upper surface (21); a step (206) of providing a first side portion (80) of the outsole (20) with a peripheral edge (82); a step (207) of providing a second side portion (90) of the outsole (20) with a peripheral edge (91); a step (208) extending the first side portion (80) generally upwards and generally perpendicular to the upper surface (21); a step (209) of extending the second side portion (90) upwards and generally perpendicular to the upper surface (21); and a step (210) of integrally connecting a rigid piece (70) to outsole (20).

In one embodiment as shown in FIG. 20, the step (210) of integrally connecting the rigid piece (70) further comprises a step (220) of joining the peripheral edge of the front region (32), the peripheral edge of the first side portion (82), and the peripheral edge of the second side portion (91) for forming toe cap (60). In another embodiment, the step (220) of joining the peripheral edge (32) of the front region (30), the peripheral edge (82) of first side portion (80, and peripheral edge (91) of second side portion (90) further includes a step of forming a continuous, rearward facing toe cap edge (37) integrally connected with the outsole (20).

In yet another embodiment as shown in FIG. 20, the step (210) of integrally connecting the rigid piece (70) to the outsole (20) further comprises the step (211) of extending the peripheral edge (32) of the front region (30) for covering the rigid material (70); a step (212) of extending the peripheral edge (82) of the first side portion (80) for covering the rigid material (70); a step (213) of extending the peripheral edge (91) of the second side portion (90) for covering the rigid material (70); and a step (214) of connecting the peripheral edges (32, 82, 91) of each the front region (30), first side portion (80), and second side portion (90) for fully enveloping the rigid material (70) in a toe cap (60).

In another embodiment as shown in FIG. 20, the step (210) of integrally connecting the rigid material (70) with the outsole (20) comprises a step of providing the peripheral edge (32) of the front region (30) with a top portion (35) and a bottom portion (36); a step (221) of extending the top portion (35) of the front region peripheral edge (32) for covering an upper surface (71) of the rigid material (70); a step (222) of extending the bottom portion (36) of the front region peripheral edge (32) for covering a bottom surface (72) of the rigid material (70); a step providing the peripheral edge (82) of the first side portion (80) with a top portion (83) and a bottom portion (84); a step (223) extending the top portion (83) of the peripheral edge (82) of the first side portion (80) for covering the rigid material upper surface (71); a step (224) extending the bottom portion (84) of the peripheral edge (82) of the first side portion (80) for covering the rigid material bottom surface (72); a step of providing the peripheral edge (91) of the second side portion (90) with a top portion (92) and a bottom portion (93); a step (225) extending the top portion (92) of the peripheral edge (91) of the second side portion (90) for covering the rigid material upper surface (71); a step (226) extending the bottom portion (93) of the peripheral edge (91) of the second side portion (90) for covering the rigid material bottom surface (72); and a step (227) connecting said top (35) and bottom (36) portions of said peripheral edge (32) of said front region (30), said top (83) and bottom (84) portions of said peripheral edge (82) of said first side portion (80), and said top (92) and bottom (93) portions of said peripheral edge (91) of said second side portion (90) for forming a toe cap (60) integrally connected with the rigid material (70) and the outsole (20).

In one embodiment as shown in FIGS. 16 and 18, the method (200) for forming an outsole (20) further includes providing a third side portion (180); providing the third side portion (180) with a peripheral edge (181) having a top portion (182) and a bottom portion (183); extending the top portion (182) of the third side portion peripheral edge (181) for covering the rigid material upper surface (71); extending the bottom portion (183) of the third side peripheral edge for covering the rigid material bottom surface (72); and connecting said top (35) and bottom (36) portions of said peripheral edge (32) of said front region (30), said top (83) and bottom (84) portions of said peripheral edge (82) of said first side portion (80), said top (92) and bottom (923) portions of said peripheral edge (91) of said second side portion (90), and said top (182) and bottom (183) portions of said peripheral edge (181) of said third side portion (180) for forming a toe cap (60) integrally connected with the rigid material (70) and the outsole (20).

In one embodiment as shown in FIGS. 16 and 18, the method (200) for forming an outsole (20) further includes providing a fourth side portion (190); providing the fourth side portion (190) with a peripheral edge (191) having a top portion (192) and a bottom portion (193); extending the top portion (192) of the fourth side portion peripheral edge (191) for covering the rigid material upper surface (71); extending the bottom portion (193) of the fourth side peripheral edge (191) for covering the rigid material bottom surface (72); and connecting said top (35) and bottom (36) portions of said peripheral edge (32) of said front region (30), said top (83) and bottom (84) portions of said peripheral edge (82) of said first side portion (80), said top (92) and bottom (923) portions of said peripheral edge (91) of said second side portion (90), said top (182) and bottom (183) portions of said peripheral edge (181) of said third side portion (180), and said top (192) and bottom (193) portions of said peripheral edge (191) of said third side portion (190) for forming a toe cap (60) integrally connected with the rigid material (70) and the outsole (20).

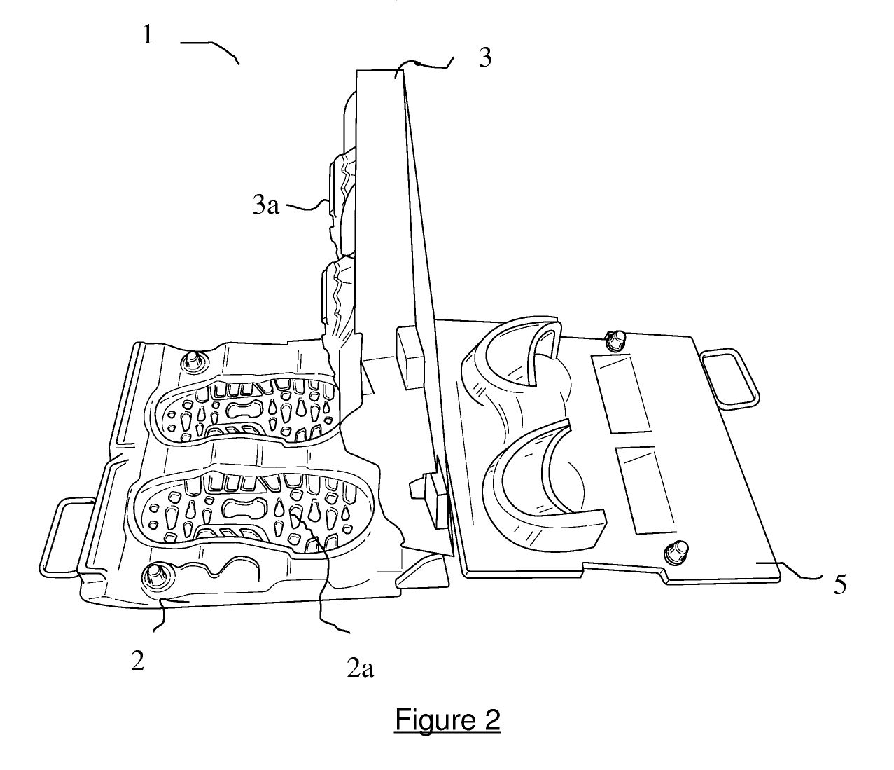

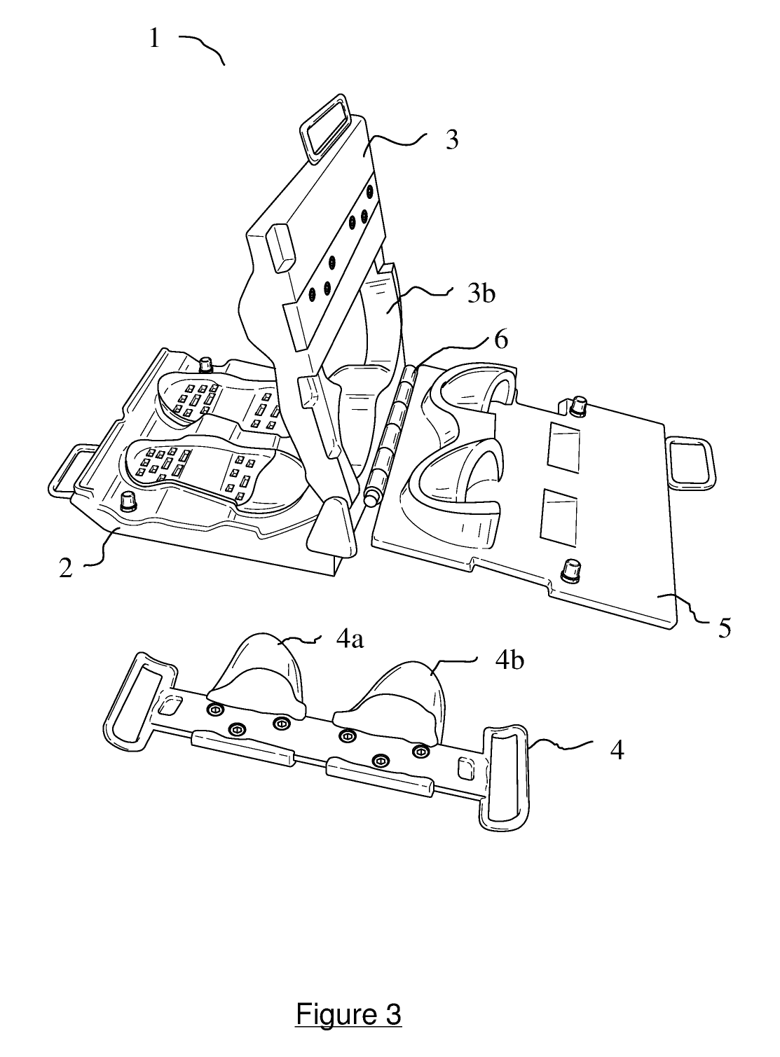

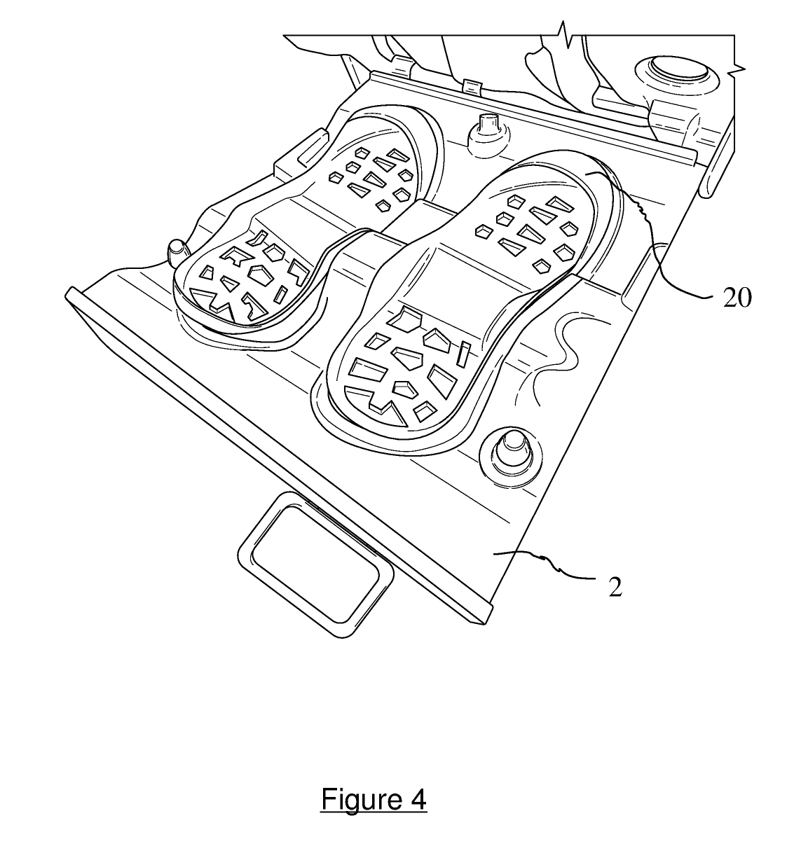

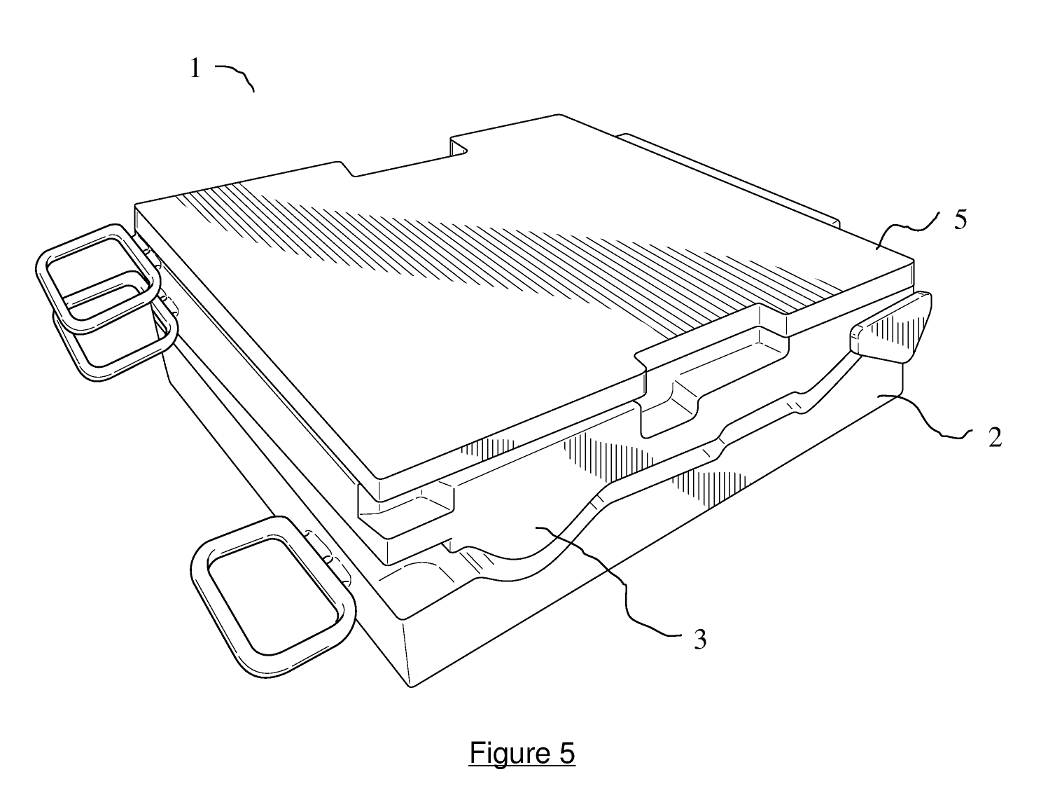

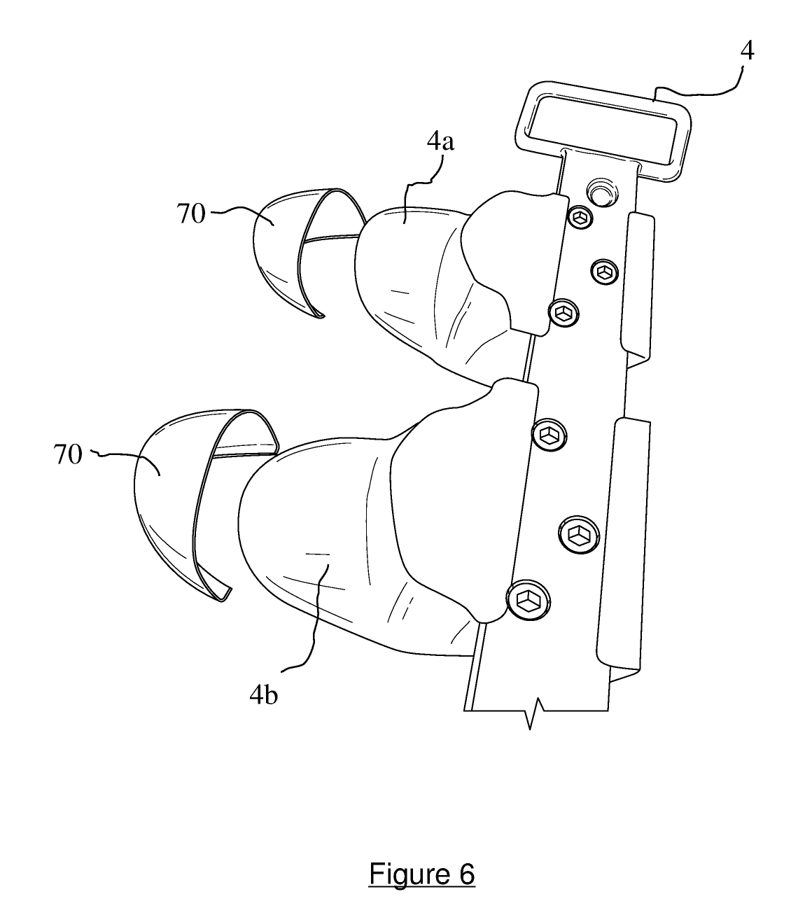

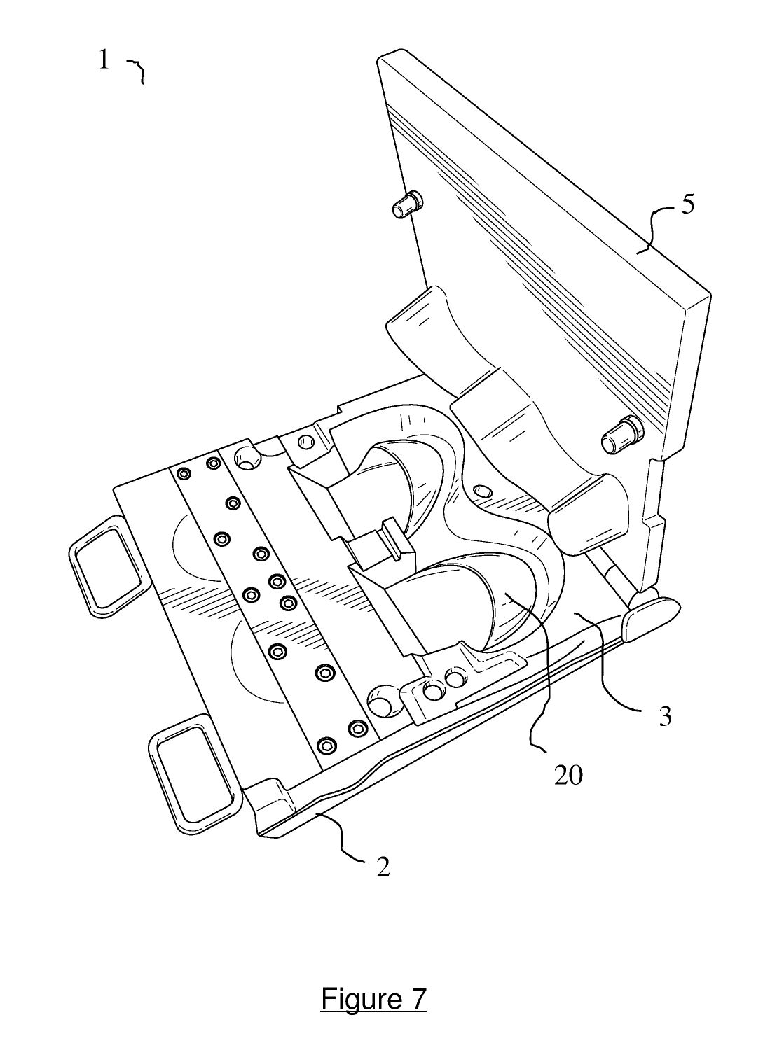

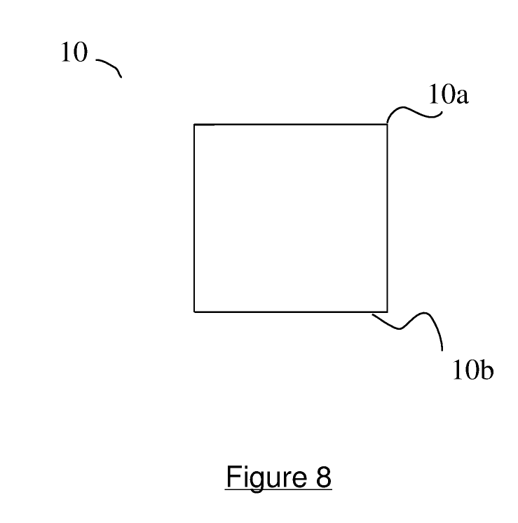

In one embodiment of this invention for constructing the outsole of FIG. 1, a mold (1) is provided for shaping outsole (20) as shown in FIGS. 2-7. The mold (1) includes a bottom lid (2) (FIG. 2) having a bottom lid cavity (2a) for shaping the bottom portion (22) of the outsole (20) during the heating process. The mold (1) further includes a middle lid (3) having a middle lid cavity (3a) (FIG. 2) for shaping the upper portion (21) of the outsole (20) as shown in FIG. 9. The middle lid (3) further includes a middle lid gap (3b) (FIG. 3) for receiving a toe cap lid (4). As shown in FIG. 6, the toe cap lid (4) comprises rounded projections (4a,4b) for forming the bottom portion (62) of the toe cap (60) during the heating process. The toe cap lid (4), as shown in FIG. 6, is also instrumental in defining the empty space (38), shown in FIG. 14, between the upper portion (21) of the outsole (20) and the bottom portion (62) of the resulting toe cap (60) during the heating process. This empty space (38) receives the wearer's toes during use. As shown in FIG. 3, the mold (1) further includes a top lid (5) for shaping the top portion (61) of the toe cap (60) during the heating process, as shown in FIG. 14. In one embodiment, the bottom lid (2), middle lid (3), and top lid (5) are connected at the same hinged junction (6) as shown in FIG. 3. In another embodiment, the toe cap lid (4) is not connected at the hinged junction (6) and is instead an independent piece. In another embodiment, the bottom lid (2), middle lid (3), toe cap lid (4), and top lid (5) are separate pieces, as shown in FIG. 2.

In one embodiment as shown in FIG. 5, an outsole (20) is formed by first warming the mold (1) to approximately 155 degrees Celsius; placing a first raw material (10) onto the bottom lid (2); placing the middle lid (3) onto the bottom lid (2) by rotating the middle lid (3) through the hinged junction (6) so that the raw material (10) is between the bottom (2) and middle lids (3); placing a second raw material onto the toe cap lid (4); placing the toe cap lid (4) through and within the middle lid gap (3b) by rotating the toe cap lid (4) through the hinged junction (6); placing the top lid (5) onto the middle lid (3) by rotating the top lid (5) through the hinged junction (6) so that the second raw material is between the toe cap lid (4) and the top lid (5); securing the mold (1) with a fastener; heating the mold (1) for approximately 800 seconds at approximately between 165 degrees Celsius and 200 degrees Celsius; cooling the mold (1) to approximately 20 degrees Celsius; opening the top lid (5); removing the toe cap lid (4); opening the middle lid (3); and removing the finished outsole (20). In another embodiment, the toe cap lid (4) is utilized by steps of sliding the toe cap lid (4) through and within the middle lid gap (3b).

As shown in FIG. 20, another embodiment further includes a step (202) of shaping the bottom portion (22) of the outsole (20); shaping the top portion (21) of the outsole (20); shaping the bottom portion (62) of the toe cap (60); shaping the upper portion (61) of the toe cap (60); wherein shaping the bottom (62) and upper (61) portions of the toe cap (60) further define an empty space (38) for receiving the wearer's toes.

In another embodiment of this invention as shown in FIGS. 19-20, a step (104, 210) of providing a rigid, durable material (70) is included. After the step of rotating the middle lid (3) onto the bottom lid (2), there is a step (104, 210) of placing a rigid, durable material (70) onto the toe cap lid (4), followed by the step of placing the second raw material onto the toe cap lid (4). In this embodiment, the upper portion (61) of the toe cap (60) extends over the rigid material (70) while the bottom portion (62) of the toe cap (60) extends under the rigid material (70), the upper portion (61) and bottom portion (62) further connecting at a toe cap edge (37) for wholly encapsulating the rigid material (70).

In another embodiment, a curing agent is added to the first and second raw materials to add rigidity and stability during the heating step. In one embodiment, the first and second raw materials are the same material. In another embodiment, the first raw material is different from the second raw material. In yet another embodiment, a third raw material is used.

Applicant has advantageously found that encapsulating the rigid material (70) between a top (61) and bottom (62) layer of the toe gap (60) greatly improves a number of attributes of the toe cap (60), such as impact protection compression, antistatic resistance, water penetration and resistance, outsole penetration resistance, heat resistance, conductive resistance, and cold and heat insulation.

In one embodiment as shown in FIGS. 16-17, each of the toe cap top layer (61) and bottom layer (62) has a width of approximately 1.0 mm to approximately 3.0 mm. In one embodiment, the top (61) and bottom (62) layer of the toe cap (60) each have a width of approximately between 1.0 mm and 1.7 mm, ideally between approximately 1.4 mm and 1.6 mm for a better ratio of protection to comfort. Applicant has advantageously found that when the top (61) and bottom (62) layers of the toe cap (60) each have a width of approximately between 1.0 mm and 1.7 mm, the toe cap (60) exhibits greatly increased properties. Specifically, the toe cap (60) can endure compressions of up to 12,000 Newtons, penetration resistance of up to 900 Newtons, heat resistance of up to 250 degrees Celsius, conductive max resistant of up to 70,000 Ohms, an anti-static range of 100,000 Ohms to 500 mega-Ohms, and improved water, cold, and heat insulation. Applicant has also advantageously found that in an embodiment wherein the top (61) and bottom (62) layers of the toe cap (60) each have a width of approximately 1.5 mm, the toe cap (60) exhibits the greatest balance between the above-mentioned properties as well as comfort and flexibility for the wearer.

In another embodiment as shown in FIGS. 16-17, the top (61) and bottom layers (62) of the toe cap (60) each have a width of approximately between 1.71 mm and 2.4 mm, ideally between approximately 1.9 mm and 2.1 mm for a better ration of protection to comfort. Applicant has advantageously found that when the top (61) and bottom (62) layers of the toe cap (60) each have a width of approximately between 1.71 mm and 2.4 mm, the toe cap (60) exhibits greatly increased properties. Specifically, the toe cap (60) can endure compressions of up to 15,000 Newtons, penetration resistance of up to 1,100 Newtons, heat resistance of up to 300 degrees Celsius, conductive max resistant of up to 100,000 Ohms, an anti-static range of 100,000 Ohms to 1,000 mega-Ohms, and greatly improved water, cold, and heat insulation. Applicant has also advantageously found that in an embodiment wherein the top (61) and bottom (62) layers of the toe cap (60) each have a width of approximately 2.0 mm, the toe cap (60) exhibits the greatest balance between the above-mentioned properties as well as comfort and flexibility for the wearer.

In another embodiment as shown in FIGS. 16-17, the top (61) and bottom layers (62) of the toe cap (60) each have a width of approximately between 2.41 mm and 3.0 mm, ideally between approximately 2.6 mm and 2.8 mm for a better ratio of protection to comfort. Applicant has advantageously found that when the top (61) and bottom layers (62) of the toe cap (60) each have a width of approximately between 2.4 mm and 3.0 mm, the toe cap (60) exhibits further greatly increased properties. Specifically, the toe cap (60) can endure compressions of up to 18,000 Newtons, penetration resistance of up to 1,300 Newtons, heat resistance of up to 350 degrees Celsius, conductive max resistant of up to 120,000 Ohms, an anti-static range of 100,000 Ohms to 1,500 mega-Ohms, and greatly improved water, cold, and heat insulation. Applicant has also advantageously found that in an embodiment wherein the top (61) and bottom layers (62) of the toe cap (60) each has a width of approximately 2.7 mm, the toe cap (60) exhibits the greatest balance between the above-mentioned properties as well as comfort and flexibility for the wearer.

The present disclosure includes that contained in the appended claims, as well as that of the foregoing description. Although this invention has been described in its form with a certain degree of particularity, it is understood that the present disclosure of the forms have been made only by way of example and that numerous changes in the details of construction and the combination and arrangement of parts may be resorted to without departing from the spirit and scope of the invention.

I claim:

1. A method for forming an outsole of a shoe, comprising the steps of:
providing a raw material;
extending a first part of said raw material forward for forming a toe region;
extending a second part of said raw material away from said first part for forming a heel region;
placing a rigid material onto a top portion of said toe region; and
shaping a toe cap by extending said top portion of said toe region around said rigid material.

2. The method of forming an outsole of a shoe according to claim 1, wherein the step of shaping said toe cap comprises the step of extending said top portion of said toe region generally upwards and generally perpendicular to an upper portion of said outsole for forming a first edge.

3. The method of forming an outsole of a shoe according to claim 2, further comprising a step of extending said first edge rearwardly and generally parallel to said upper portion of said outsole.

4. The method of forming an outsole of a shoe according to claim 3, further comprising a step of extending a side of said outsole upwards and generally perpendicular to said upper portion of said outsole for forming a second edge.

5. The method of forming an outsole of a shoe according to claim 4, further comprising a step of connecting said first and second edges for forming said toe cap.

6. The method of forming an outsole of a shoe according to claim 5, further comprising a step of integrally connecting said outsole and said toe cap for forming said outsole toe cap around said rigid material.

7. An outsole for a shoe, comprising:
a bottom surface;
a top surface;
a heel region;
a toe region;
a midsole region;
wherein said toe region includes a protrusion that extends generally perpendicular in relation to said top surface to produce a generally perpendicular front region; and
said protrusion further extends rearward toward said heel region and generally parallel in relation to said top surface to produce a toe cap.

8. The outsole of claim 7, wherein said toe cap further includes sidewalls.

9. The outsole of claim 8, wherein said sidewalls are secured to a peripheral edge of said toe region.

10. The outsole of claim 9, wherein said toe cap further includes an open cavity defined by a rearward facing edge.

11. The outsole of claim 7, further including a piece of rigid material secured to said toe region.

12. The outsole of claim 11, wherein said piece of rigid material is encapsulated within said toe cap.

13. The outsole of claim 12, wherein said outsole is formed from a first raw material.

14. The outsole of claim 13, wherein said toe cap is formed from a second raw material.

15. The outsole of claim 14, wherein said toe cap and said outsole are integrally connected as a single piece.

16. A method for forming an outsole for a shoe, comprising the steps of:
providing a first raw material;
shaping said first raw material into an outsole having a bottom surface and an upper surface;
extending a front region of said upper surface generally upwards and generally perpendicular to said upper surface of said outsole;
further extending said front region of said upper surface generally rearwards and generally parallel to said upper surface of said outsole;
providing said front region with a peripheral edge;
extending a first side portion of said upper surface generally upwards and generally perpendicular to said upper surface of said outsole;
extending a second side portion said upper surface generally upwards and generally perpendicular to said upper surface of said outsole;
providing said first and second side portions with a peripheral edge;
joining said peripheral edge of said front region, said peripheral edge of said first side portion; and said peripheral edge of said second side portion for defining a continuous, rearward facing toe cap edge integrally connected with said outsole.

17. The method for forming an outsole of a shoe according to claim 16, further comprising a step of integrally connecting a rigid piece within said toe cap.

18. The method for forming an outsole of a shoe according to claim 17, wherein the step of integrally connecting said rigid piece within said toe cap further comprises the steps of:
extending said peripheral edge of said front region for covering said rigid material;
extending said peripheral edge of said first side portion for covering said rigid material; and
extending said peripheral edge of said second side portion for covering said rigid material.

19. The method for forming an outsole of a shoe according to claim 18, further comprising the step of connecting each of said peripheral edge of said front region, said peripheral edge of said first portion, and said peripheral edge of said second side portion for fully covering said rigid material.

20. The method for forming an outsole of a shoe according to claim 17, wherein the step of integrally connecting said rigid piece within said toe cap further comprises the steps of:
extending a top portion of said peripheral edge of said front region for covering an upper surface of said rigid material;
extending a bottom portion of said peripheral edge of said front region for covering a bottom surface of said rigid material;
extending a top portion of said peripheral edge of said first side portion for covering said upper surface of said rigid material;
extending a bottom portion of said peripheral edge of said first side portion for covering said bottom surface of said rigid material;
extending a top portion of said peripheral edge of said second side portion for covering said upper surface of said rigid material;
extending a bottom portion of said peripheral edge of said second side portion for covering said bottom surface of said rigid material; and
connecting said top and bottom portions of said peripheral edge of said front region, said top and bottom portions of said peripheral edge of said first side portion, and said top and bottom portions of said peripheral edge of said second side portion.
